(19) United States
(12) Patent Application Publication
(10) Pub. No.: US 2015/0281586 A1
(43) Pub. Date: Oct. 1, 2015

(54) METHOD AND APPARATUS FOR FORMING A VIDEO SEQUENCE

(71) Applicant: NOKIA CORPORATION, Espoo (FI)

(72) Inventors: Sujeet Shyamsundar Mate, Tampere (FI); Igor Danilo Diego Curcio, Tampere (FI)

(21) Appl. No.: 14/436,417

(22) PCT Filed: Dec. 18, 2012
(86) PCT No.: PCT/FI2012/051257

§ 371 Date: Apr. 16, 2015

(51) Int. Cl. H04N 5/232

(52) U.S. Cl. CPC H04N 5/23296; H04N 5/23216; H04N 5/23245

(57) ABSTRACT

A method for providing a video sequence comprises: obtaining reference image data associated with an identifier, obtaining primary image data, forming a first primary image from the primary image data, determining whether a sub-image of the first primary image is a known sub-image by comparing the first primary image with the reference image data, determining the position of a first image portion based on the position of the known sub-image in the first primary image, forming a first image frame from the primary image data according to the position of the first image portion, forming a second image frame from the primary image data according to the position of a second image portion, and forming a video sequence, which comprises a first video shot and a second video shot, wherein the first video shot comprises the first image frame, and the second video shot comprises the second image frame.

### FIELD

Various embodiments relate to providing a video sequence.

### BACKGROUND

It is known that the orientation of a video camera and the zoom level may be changed manually during recording a video sequence. For example, the user of a video camera may manually change the orientation of the video camera during the recording in order to capture a close up shot of an object. The user may manually change the zoom level during the recording in order to capture a wide angle shot, which shows several objects.

### SUMMARY

Some embodiments provide a method for providing a video sequence. Some embodiments provide a computer program for providing a video sequence. Some embodiments provide a computer program product comprising a computer program for providing a video sequence. Some embodiments provide an apparatus for providing a video sequence. Some embodiments provide a means for providing a video sequence.

According to a first aspect, there is provided a method comprising:
obtaining reference image data associated with an identifier,
obtaining primary image data,
forming a first primary image from the primary image data,
determining whether a sub-image of the first primary image is a known sub-image by comparing the first primary image with the reference image data,
determining the position of a first image portion based on the position of the known sub-image in the first primary image,
forming a first image frame from the primary image data according to the position of the first image portion,
forming a second image frame from the primary image data according to the position of a second image portion, and
forming a video sequence, which comprises a first video shot and a second video shot, wherein the first video shot comprises the first image frame, and the second video shot comprises the second image frame.

According to a second aspect, there is provided a computer program comprising computer program code configured to, when executed on at least one processor, cause an apparatus or a system to:
obtain reference image data associated with an identifier,
obtain primary image data,
form a first primary image from the primary image data,
determine whether a sub-image of the first primary image is a known sub-image by comparing the first primary image with the reference image data,
determine the position of a first image portion based on the position of the known sub-image in the first primary image,
form a first image frame from the primary image data according to the position of the first image portion,
form a second image frame from the primary image data according to the position of a second image portion, and
form a video sequence, which comprises a first video shot and a second video shot, wherein the first video shot comprises the first image frame, and the second video shot comprises the second image frame.

According to a third aspect, there is provided a computer program product embodied on a non-transitory computer readable medium, comprising computer program code configured to, when executed on at least one processor, cause an apparatus or a system to:
obtain reference image data associated with an identifier,
obtain primary image data,
form a first primary image from the primary image data,
determine whether a sub-image of the first primary image is a known sub-image by comparing the first primary image with the reference image data,
determine the position of a first image portion based on the position of the known sub-image in the first primary image,
form a first image frame from the primary image data according to the position of the first image portion,
form a second image frame from the primary image data according to the position of a second image portion, and
form a video sequence, which comprises a first video shot and a second video shot, wherein the first video shot comprises the first image frame, and the second video shot comprises the second image frame.

According to a fourth aspect, there is provided a means for providing a video sequence, comprising:
means for obtaining reference image data associated with an identifier,
means for obtaining primary image data,
means for forming a first primary image from the primary image data,
means for determining whether a sub-image of the first primary image is a known sub-image by comparing the first primary image with the reference image data,
means for determining the position of a first image portion based on the position of the known sub-image in the first primary image,
means for forming a first image frame from the primary image data according to the position of the first image portion,
means for forming a second image frame from the primary image data according to the position of a second image portion, and
means for forming a video sequence, which comprises a first video shot and a second video shot, wherein the first video shot comprises the first image frame, and the second video shot comprises the second image frame.

According to a fifth aspect, there is provided an apparatus comprising at least one processor, a memory including computer program code, the memory and the computer program code configured to, with the at least one processor, cause the apparatus to perform at least the following:
obtain reference image data associated with an identifier,
obtain primary image data,
form a first primary image from the primary image data,
determine whether a sub-image of the first primary image is a known sub-image by comparing the first primary image with the reference image data,
determine the position of a first image portion based on the position of the known sub-image in the first primary image,
form a first image frame from the primary image data according to the position of the first image portion,
form a second image frame from the primary image data according to the position of a second image portion, and
form a video sequence, which comprises a first video shot and a second video shot, wherein the first video shot comprises the first image frame, and the second video shot comprises the second image frame.

Two or more videos shots may be extracted from a preliminary image data stream so that a first video shot has a first digital zoom level (i.e. second digital image magnification) and a second video shot has a second digital zoom level (i.e. second digital image magnification). The first video shot, the second video shot, and optional further video shots may be combined in different temporal segments to form a video sequence.

According to an embodiment, a mixed video sequence comprising a close-up shot and a wide angle shot may be formed from preliminary image data based on object recognition without intervention by a user. The video sequence may be generated e.g. by using a rule for selecting one or more objects of interest, a first zoom level for a close-up shot, a second zoom level for a wide-angle shot, and a timing scheme. The mixed video sequence may contain data for reproducing relevant details of an event with high resolution but also a more general view of said event. The event may be e.g. a sporting event, a musical concert, a festival or a wedding ceremony.

The mixed video sequence may be stored and/or transmitted instead of the preliminary image data. This may substantially reduce the need for memory space and/or transmission capacity. In an embodiment, a large amount of data obtained from an image sensor may be discarded. The memory space needed for storing the video sequence may be reduced and/or the image data may be processed at a lower speed. Costs and/or energy consumption of image processing may be reduced. The video sequence may be stored in less memory space.

The time delay between an event and providing the video sequence representing the event may be substantially reduced. The mixed video sequence may be provided substantially in real time.

The apparatus may comprise an image sensor, which may be configured to capture a large field of view. The position of an image portion may be determined based on object recognition. A part of the captured scene may be selected according to the image portion to form a video shot to be incorporated in the video sequence. The full sensor resolution may be high, and the selected part of the captured scene may be encoded to generate a lower but acceptable resolution. Video shots formed according to different image portions may be treated as different camera views, and the video shots may be subsequently mixed in different temporal segments of a video sequence. The video sequence may be called e.g. as a multi-perspective remix. In an embodiment, the video sequence may be formed from primary image data provided by only one image sensor.

In an embodiment, a single mobile (portable) device comprising a high resolution image sensor may be arranged to capture image data, and to automatically generate a high-quality video sequence, which contains several video shots showing at least one detail with high resolution and also a more general view of an event.

The preliminary image data may be captured without manually adjusting camera position and/or zoom value during optical exposure of an image sensor. Thus, unpleasant image shaking may be substantially avoided.

In an embodiment, a video sequence comprising a close-up shot and a wide angle shot may be captured by a camera so that the user does not need to manually change the mechanical orientation of the camera and the zoom level during capturing image data. Once a video script has been created or selected, the recording of the video sequence according to the video script may be started e.g. by pressing a button or by touching a virtual key of the camera. The video sequence may be captured so that the video shots may be stable, and so that the transitions between consecutive video shots may be smooth. The user does not need to move the camera during the recording. The camera may be kept substantially steady by free hand or by using a support, e.g. a tripod. The recorded video images may be rapidly and accurately framed also without a need to use a tripod with a mechanically turning head. Thus, the camera may also be positioned e.g. on nearly any support which happens to be available. For example, a table or a branch of a tree may be used as a support for the camera when recording the video sequence.

In an embodiment, the user does not need to support the camera manually during recording the video sequence. In particular, the user does not need to manually support and aim the camera during recording the video sequence.

In an embodiment, the camera may comprise an image stabilizer, which is arranged to reduce the effect of unintentional mechanical shaking on the video images. However, it may sometimes be difficult to distinguish intentional movements from unintentional shaking, and using the stabilizer may cause delayed or inaccurate framing also when the user intentionally changes the orientation of the camera in order to aim the camera at the object of interest. Thanks to capturing the video shots based on the object recognition and based on the predetermined timing scheme, the transition from a first framing to a second framing may be provided accurately and/or substantially without a delay even when the optical stabilizer is arranged to reduce image blurring.

### BRIEF DESCRIPTION OF THE DRAWINGS

In the following examples, various embodiments will be described in more detail with reference to the appended drawings of example embodiments, in which

FIG. 1a shows, by way of example, an apparatus for providing a video sequence from primary image data,

FIG. 1b shows, by way of example, an apparatus comprising an image sensor for providing primary image data,

FIG. 2a shows, by way of example, forming an optical image on an image sensor,

FIG. 2b shows, by way of example, a primary image formed from primary image data obtained from the image sensor of FIG. 2a,

FIG. 2c shows, by way of example, the image sensor of FIG. 2a,

FIG. 3 shows, by way of example, defining an operating mode,

FIG. 4 shows, by way of example, reference image data associated with a person,

FIG. 5a shows, by way of example, a user interface for displaying a script,

FIG. 5b shows, by way of example, a user interface for defining a script,

FIG. 6a shows, by way of example, forming image frames from primary image data,

FIG. 6b shows, by way of example, the timing of video shots of a video sequence,

FIG. 6c shows, by way of example, the timing of video shots of a video sequence,

FIG. 7 shows, by way of example, forming image frames from primary image data,

FIG. 8 shows, by way of example, method steps for forming and displaying a video sequence,

FIG. 9 shows, by way of example, a system for providing reference image data and for forming a video sequence by using the reference image data,

FIG. 10a shows, by way of example, a portable device for forming a video sequence,

FIG. 10b shows, by way of example, a portable device for capturing primary image data and for forming a video sequence from the primary image data,

FIG. 11a shows, by way of example, a server for providing a video distributing service,

FIG. 11b shows, by way of example, a server for providing a social networking service,

FIG. 11c shows, by way of example, a server for forming a video sequence, and

FIG. 11d shows, by way of example, a server for storing the video sequence.

### DETAILED DESCRIPTION

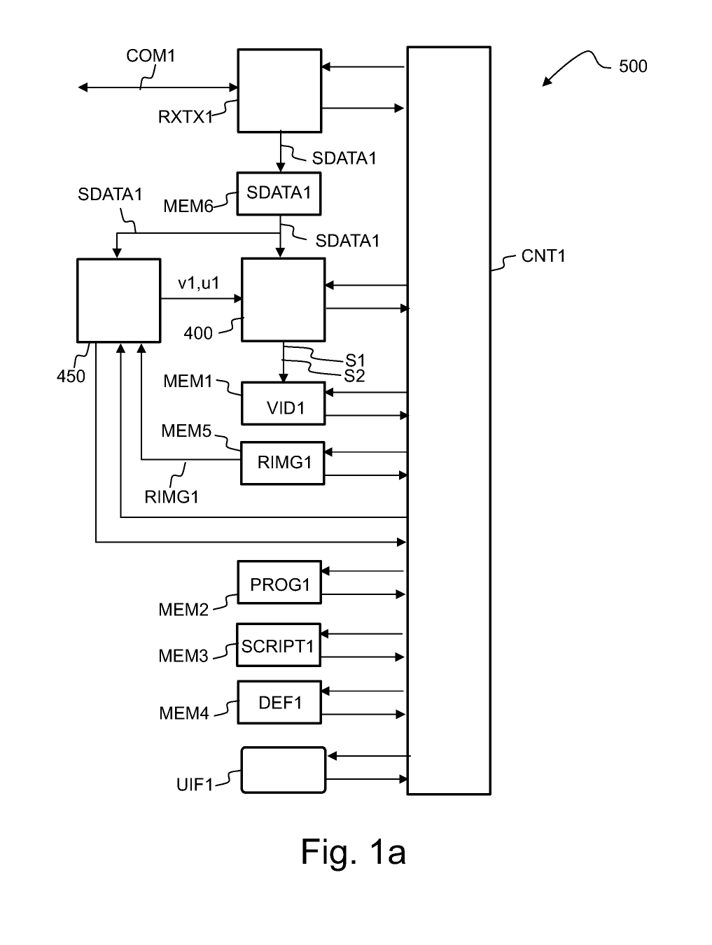

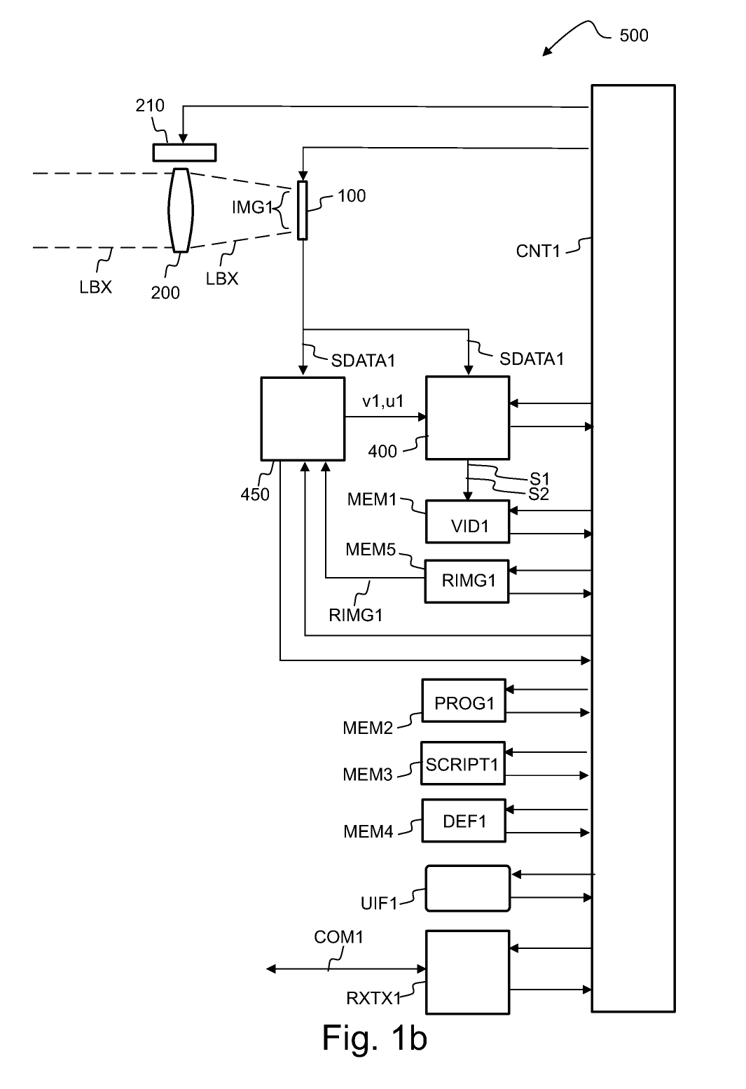

Referring to FIG. 1a, an apparatus 500 for forming the video sequence VID1 may comprise an image data processor 400 configured to form image frames from preliminary image data SDATA1. The processor 400 may form a first video shot S1, which comprises a plurality of consecutive image frames, and the processor 400 may form a second video shot S2, which comprises a plurality of consecutive image frames. In particular, a second video shot S2 may be appended to a first video shot S1 to form a video sequence VID1, which comprises the first video shot S1 and the second video shot S2. Image frames of the video shots S1, S2 may be stored in a memory MEM1 to form the video sequence VID1. The apparatus 500 may comprise a memory MEM1 for storing the video sequence VID1.

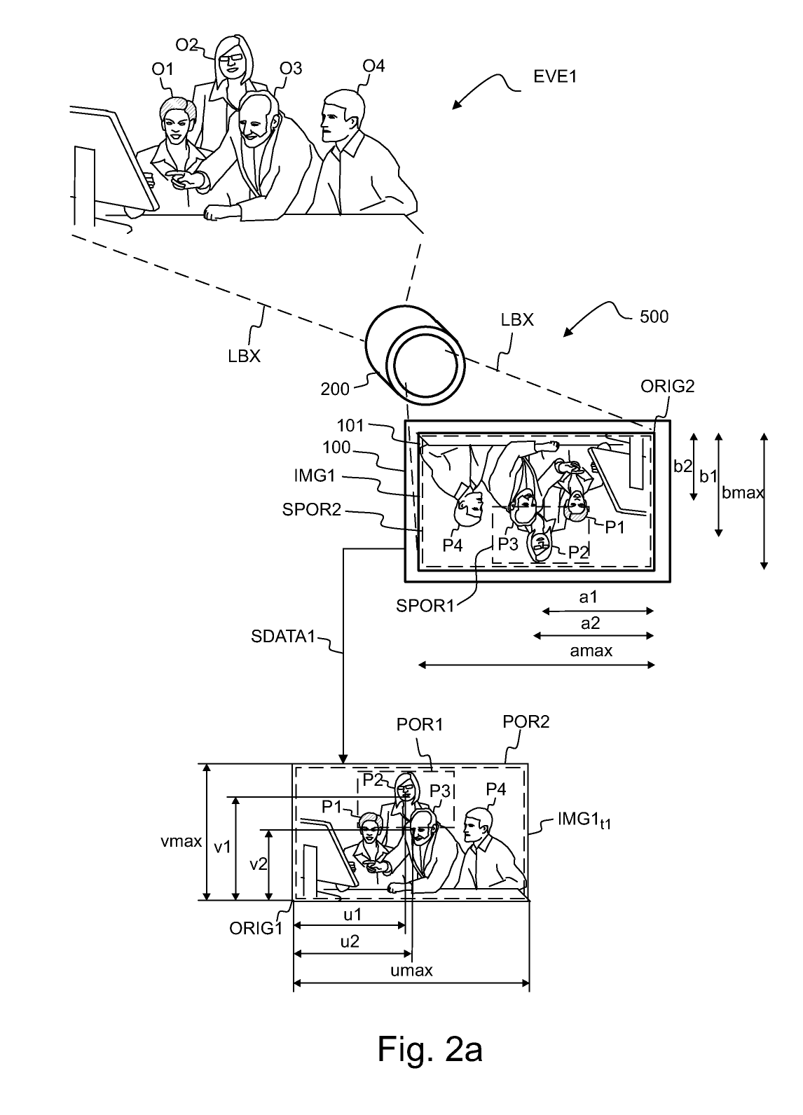

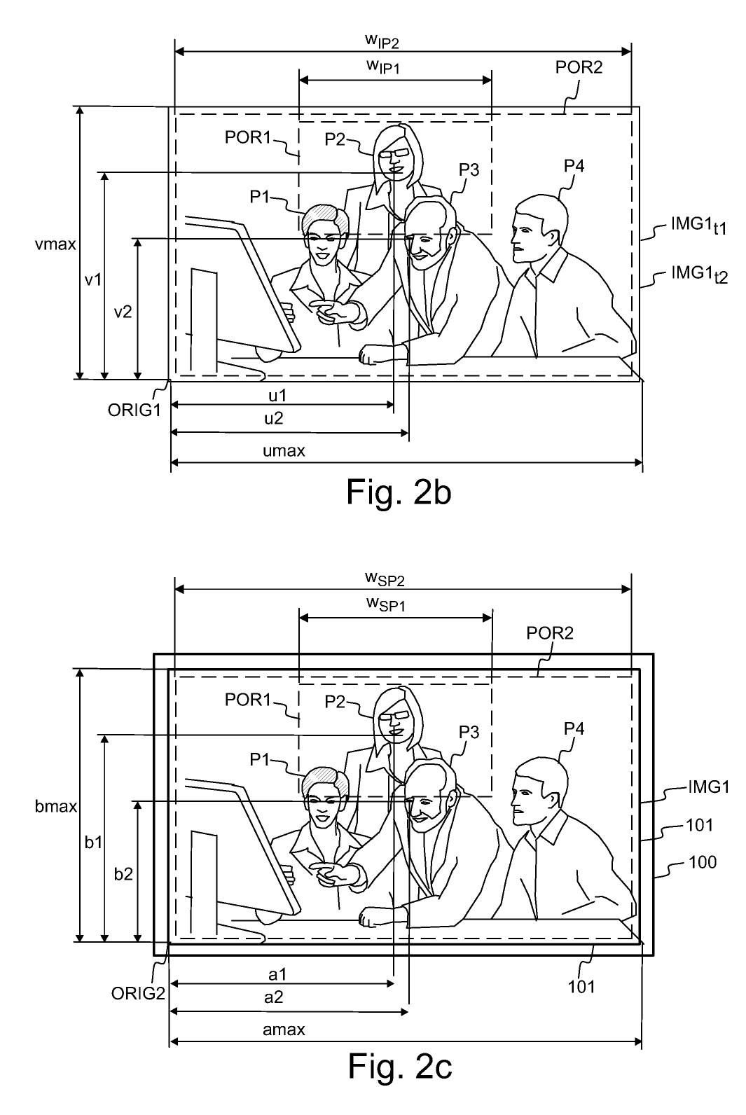

The preliminary image data SDATA1 may comprise sub-images of objects. The apparatus 500 may comprise an analysis unit 450 configured to determine whether the preliminary image data SDATA1 contains a sub-image of a known object. When the sub-image of the known object is detected, the analysis unit 450 may determine the position u1,v1 of a first image portion POR1 according to the position of the sub-image of the known object (see FIG. 2a).

The processor 400 may form an image frame of the first video shot S1 according to the spatial position u1,v1 of the first image portion POR1.

Sub-images of the preliminary image data SDATA1 may be detected and/or recognized (identified) by using the reference image data RIMG1. A sub-image may be classified to be a sub-image of a known object by comparing preliminary image data SDATA1 with reference image data RIMG1. The apparatus 500 may comprise a memory MEM5 for storing reference image data RIMG1.

The apparatus 500 may comprise a communication unit RXTX1 for receiving preliminary image data SDATA1 from a remote device e.g. via the Internet, via a mobile telephone network, or via a local area network. The communication unit RXTX1 may transmit and/or receive a signal COM1. The apparatus 500 may comprise a memory MEM6 for storing preliminary image data SDATA1. The memory MEM6 may be a buffer memory.

The video sequence VID1 may be stored in a memory MEM1 and/or the video sequence VID1 may be transmitted e.g. by using the communication unit RXTX1.

The apparatus 500 may be configured to store at least one image frame of the first video shot S1 and at least one image frame of the second video shot S2 in the memory MEM1. The apparatus 500 may be configured to store substantially all image frames of the video sequence VID1 in the memory MEM1. The memory MEM1 may be local, or the memory MEM1 may be connected to a data processor 400 via a network.

The image processing apparatus 500 may comprise one or more data processors configured to form the video sequence VID1 from the preliminary image data SDATA1. The image processing apparatus 500 may comprise a memory MEM2 for storing computer program PROG1 configured to, when executed on at least one processor, cause the apparatus 500 to form the video sequence VID1.

The image processing apparatus 500 may be configured to form the video sequence VID1 from the preliminary image data SDATA1 according to one or more operating parameters, which may together form a video script SCRIPT1. In other words, the video sequence VID1 may be formed according to a predetermined video script SCRIPT1.

The apparatus 500 may comprise a script memory MEM3 for storing a video script SCRIPT1. The video script SCRIPT1 may comprise one or more parameters, which may define e.g. a rule for selecting an image portion, the zoom level of the video shot S1, the zoom level of the video shot S2, and a timing scheme for the video shots S1, S2. The memory MEM3 may store one or more parameters, which define the video script SCRIPT1. The image processing apparatus 500 may further comprise a memory MEM4 for storing one or more default operating parameters DEF1. A default parameter DEF1 may specify e.g. default duration of the first video shot S1. A default parameter DEF1 may specify e.g. default duration of the second video shot S2. A default parameter DEF1 may specify e.g. default duration of the video sequence VID1. In an embodiment, one or more of said parameters DEF1 may also be retrieved from an external memory via a network.

The image processing apparatus 500 may comprise a control unit CNT1 for controlling operation of the apparatus 500. The control unit CNT1, the image processing unit 400, and/or the analysis unit 450 may comprise one or more data processors configured to form the video sequence VID1 according to the video script SCRIPT1. The image processing apparatus 500 may comprise one or more data processors configured to form the video sequence VID1 according to the video script SCRIPT1, which defines that one or more video shots are formed based on object recognition.

The image processing apparatus 500 may comprise a user interface UIF1 for receiving commands from a user and/or for providing information to the user. A video script SCRIPT1 for recording the video sequence VID1 may be created or modified by using the user interface UIF1. The user interface UIF1 may comprise e.g. a touch screen for visually displaying information and for receiving commands from a user. The video script SCRIPT1 may be created by using the touch screen. The user interface UIF1 may comprise hardware, e.g. a display, keypad and/or a touch screen. The user interface may comprise a display screen for viewing graphical elements displayed on the screen. The user interface UIF1 may comprise a software application e.g. for displaying various different virtual keys on a touch screen. The user interface UIF1 may comprise one or more virtual keys for receiving instructions from the user. The virtual keys may be implemented on the touch screen. The user interface UIF1 may comprise one or more push buttons for receiving instructions from the user. The user interface UIF1 may comprise a keypad for receiving instructions from the user. The user interface UIF1 may comprise a touchpad, a keypad, a mouse and/or a joystick for receiving instructions from the user. In an embodiment, the user interface UIF1 may comprise a microphone and a speech recognition unit for receiving instructions, which are spoken aloud. The user interface UIF1 may be implemented e.g. in a portable device, e.g. in a smart phone. A user may receive information via the interface UIF1. The user may control operation of the apparatus 500 by giving commands via the user interface UIF1.

The program PROG1, the video script SCRIPT1, default parameter values DEF1, and/or reference images RIMG1 may also be received via the communication unit RXTX1.

Referring to FIG. 1b the image processing apparatus 500 may further comprise an image sensor 100 and imaging optics 200 arranged to form an optical image IMG1 on the image sensor 100. The imaging optics 200 may be arranged to focus light LBX to an image sensor 100. The image sensor 100 may convert the optical image into a digital image. Preliminary image data SDATA1 obtained from the image sensor 100 may be processed by one or more data processors 400 to provide video shots S1, S2. Preliminary image data SDATA1 obtained from the image sensor 100 may be processed by one or more data processors 400 to provide an image frame of a first video shot S1 and an image frame of a second video shot S2. An apparatus 500 comprising the image sensor 100 may be called e.g. as a camera or as a camera unit. The apparatus 500 may be a portable device. The apparatus 500 may comprise a focusing actuator 210. The apparatus 500 may comprise the units and functionalities described e.g. in the context of FIG. 1a.

The image sensor 100 may comprise a two-dimensional array of light-detecting detector pixels, which cover the active area 101 of the image sensor 100. The image sensor 100 may convert the optical image IMG1 into a digital image. The image sensor 100 may comprise e.g. a CMOS array or a CCD array. The symbol IMG1 may herein refer also to the digital image, which represents the optical image. For example, the symbol IMG1ₜ₁ may refer to a digital image, which represents an optical image IMG1 formed at a time t1.

In an embodiment, the active area 101 of the image sensor 100 of the apparatus 500 may comprise e.g. more than 40·10⁶ detector pixels. The pixels may be arranged e.g. in a two-dimensional rectangular array comprising 7728×5368 pixels. Said camera 500 may have a first operating mode where the aspect ratio of the recorded image frames is 4:3, wherein the active area 101 may consist of 7152×5368 detector pixels. In this operating mode, the active area may have e.g. 38·10⁶ detector pixels.

Said camera 500 may also have a second operating mode where the aspect ratio of the recorded image frames is 16:9, wherein the active area 101 may consist of 7728×4354 detector pixels. In this operating mode, the active area may have e.g. 34·10⁶ detector pixels.

The image processor 400 may be arranged to determine the pixels of an image frame from the sensor data SDATA1 e.g. by spatial low-pass filtering and/or downsampling.

The pixels of an image frame may also be determined from the sensor data by a technique called as “oversampling”, wherein several pixels of the sensor data SDATA1 may be combined to form a single super pixel of an image frame. Thus, the speckled grainy appearance of the image captured in low lighting conditions may be greatly reduced.

In an embodiment, detector pixels of the image sensor 100 may be arranged according to the Bayer matrix, and the sensor data SDATA1 provided by the image sensor 100 may be in the RAW format, i.e. the red values, the green values and the blue values may be associated with slightly different spatial positions. The image processor 400 may be arranged to determine image data from the sensor data SDATA1 by using a de-mosaic algorithm, wherein the red value, the green value and the blue value of a pixel of the image data may be associated with the same spatial position.

In an embodiment, the user interface UIF1, the image sensor 100, and the image processor 400 may be implemented in the same housing. In an embodiment, the image sensor 100 and the user interface UIF1 may be implemented in separate housings. The user interface UIF1 may be remote from the image sensor 100.

Referring to FIG. 2a, the apparatus 500 may be used to record a video sequence VID1 of an event EVE1. The event EVE1 may involve presence of one or more objects O1, 02, O3, O4 and/or movements of the objects O1, 02, O3, O4. The optics 200 may form an optical image IMG1 on the image sensor 100, by focusing light LBX received from the objects P1, P2, P3, P4. The optical image IMG1 may comprise sub-images P1, P2, P3, P4 of the objects O1, 02, O3, O4. The image sensor 100 may convert at least a part of the optical image IMG1 into preliminary image data SDATA1. The preliminary image data SDATA1 may be transmitted and/or stored in digital form.

Also the sub-images P1, P2, P3 may be called as the “objects”, in order to simplify verbal expressions. For example, the expression “the recorded video sequence VID1 shows an object P1” means that the recorded video sequence VID1 shows a sub-image P1 of an object O1.

One or more digital images IMG1ₜ₁ may be subsequently formed from the preliminary image data SDATA1. A digital image IMG1ₜ₁ may contain sub-images P1, P2, P3, P4 of the objects O1, 02, O3, O4.

The apparatus 500 may be configured to determine whether a sub-image appearing in a digital primary image IMG1ₜ₁ matches with the image of a known object. The sub-image may be classified to be a known sub-image when the sub-image matches with the image of a known object. For example, the face of the person P2 appearing in the image IMG1ₜ₁ may match with face of a known person. The apparatus 500 may be configured to determine the position of a first image portion POR1 according to the position of the known object appearing in the image IMG1ₜ₁.

The apparatus 500 may be configured to form an image frame of a first shot S1 from preliminary image data SDATA1 according to the first image portion POR1. The apparatus 500 may be configured to form an image frame of a second shot S2 from preliminary image data SDATA1 according to a second (different) image portion POR2.

The image frame formed according to the first image portion POR1 may contain details, which are within the first image portion POR1, wherein details outside the first image portion POR1 may be substantially discarded. Image data from pixels outside the portion POR1 may be discarded or included in the image frame by using a relatively low number of bytes. Forming an image frame according to the first image portion POR1 may provide a close-up view of a detail of the event EVE1. Reducing the width of the first image portion POR1 may effectively mean increasing the zoom level. Increasing the width of the first image portion POR1 may effectively mean decreasing the zoom level.

The second image portion POR2 may be larger than the first portion POR1 so that forming an image frame according to the second image portion POR2 may provide a wide-angle view (i.e. more general view) of the event EVE1. In an embodiment, the area of the second image portion POR2 may be e.g. greater than 200% of the first image portion POR1. In an embodiment, the second image portion POR2 may cover substantially the whole digital image IMG1ₜ₁ obtained from the image sensor 100. In an embodiment, the second image portion POR2 may correspond to the whole active area of the image sensor 100.

The position of the first image portion POR1 may be specified e.g. by spatial coordinates u1,v1 with respect to a reference point ORIG1. The spatial position of the second image portion POR2 may be defined e.g. by coordinates u2,v2 with respect to the reference point ORIG1. The reference point ORIG1 may be e.g. at a predetermined corner of the primary images, e.g. at the bottom left corner. The reference point ORIG1 for the image portion POR1 may be e.g. at the bottom left corner of a first primary image IMG1ₜ₁, and the reference point ORIG1 for the image portion POR2 may be e.g. at the bottom left corner of a second primary image IMG1ₜ₂.

The first close-up shot S1 may be formed according to the size and position of the image portion POR1. The spatial position of a detected known object may be determined with respect to the reference point ORIG1. The position u1, v1 of the image portion POR1 may be determined according to the position of the known object appearing in the image IMG1ₜ₁. The known object may be e.g. the face of the person P2.

The size of the image portion POR1 may be determined e.g. according to the predefined zoom level ZLD. The size of the image portion POR1 may be determined e.g. according to the size of the known object as it appears in the digital image IMG1ₜ₁.

The width of the digital primary image IMG1ₜ₁ may be equal to umax, and the height of the digital primary image IMG1ₜ₁ may be vmax. The maximum width of an image portion may be equal to umax, and the maximum height of an image portion may be equal to vmax.

The first image portion POR1 may represent primary image data obtained from a first sensor portion SPOR1, and the second image portion POR2 may represent primary image data obtained from a second sensor portion SPOR2. The first sensor portion SPOR1 and the second sensor portion SPOR2 may be portions of the active area 101 of the image sensor 100.

The position of the first sensor portion SPOR1 may be specified e.g. by coordinates a1,b1 with respect to a reference point ORIG2. The position of the second sensor portion SPOR2 may be specified e.g. by coordinates a2,b2 with respect to the reference point ORIG2. The reference point ORIG2 may be e.g. at a predetermined corner of the active area 101. The width of the active area 101 may be equal to amax, and the height of the active area may be bmax. The maximum width of a sensor portion may be equal to amax, and the maximum height of a sensor portion may be equal to bmax.

The apparatus 500 may be configured to determine the position a1,b1 of a first sensor portion SPOR1 according to the position of the known object. The apparatus 500 may be configured to form an image frame from preliminary image data SDATA1 obtained from the first sensor portion SPOR1. The image frame may contain details, which are captured by the first sensor portion SPOR1, wherein details outside the first sensor portion SPOR1 may be substantially discarded. Image data from pixels outside the sensor portion SPOR1 may be discarded or included in the image frame by using a relatively low number of bytes. Forming an image frame from preliminary image data SDATA1 obtained from the first sensor portion SPOR1 may provide a close-up view of a detail of the event EVE1. Reducing the width of the first sensor portion SPOR1 may effectively mean increasing the zoom level. Increasing the width of the first sensor portion SPOR1 may effectively mean decreasing the zoom level.

The second sensor portion SPOR2 may be larger than the first sensor portion SPOR1 so that forming an image frame from preliminary image data SDATA1 obtained from the second sensor portion SPOR2 may provide a wide-angle view (i.e. more general view) of the event EVE1. The area of the second sensor portion SPOR2 may be e.g. greater than 200% of the first sensor portion SPOR1. In an embodiment, the second sensor portion SPOR2 may cover substantially the whole active area 101 of the image sensor 100. In an embodiment, the second sensor portion SPOR2 may be smaller than the active area 101 of the image sensor 100.

An image frame of the first close-up shot S1 may be formed from preliminary image data SDATA1 obtained from the first sensor portion SPOR1. The position a1,b1 of the sensor portion SPOR1 may be determined according to the position of the known object appearing in the image IMG1ₜ₁. When the known object (e.g. known face) is detected in the primary image IMG1ₜ₁, the position of the first sensor portion SPOR1 may be determined such that the position a1,b1 of the first sensor portion SPOR1 with respect to the active area 101 substantially corresponds to the position of the sub-image of the known object (e.g. known face) with respect to the primary image IMG1ₜ₁. The position of the first sensor portion SPOR1 may be determined such that said sub-image of the image IMG1ₜ₁ may be formed from the preliminary image data SDATA1 obtained from the first sensor portion SPOR1. The position of the first sensor portion SPOR1 may be determined such that said sub-image of the image IMG1ₜ₁ cannot be formed without using preliminary image data SDATA1 obtained from the first sensor portion SPOR1.

Referring to FIG. 2b, the first image portion POR1 may have a width w_{IP1}, and the second image portion POR2 may have a width w_{IP2}. The width w_{IP1} of the image portion POR1 may be determined e.g. according to the predefined zoom level ZLD or the width w_{IP1} of the image portion POR1 may be determined according to the size of the known object as it appears in the digital image IMG1ₜ₁. The second image portion POR2 may be substantially broader than the first image portion POR1. The relative width w_{IP2}/umax of the second image portion POR2 may be substantially greater than the relative width w_{IP1}/umax of the first image portion POR1. The dimension umax may refer to the width of a digital image IMG1ₜ₁, whose area corresponds to the whole active area 101 of the image sensor 100.

The first image portion POR1 may be a portion of a first primary image IMG1ₜ₁, and the second image portion POR2 may be a portion of a second primary image IMG1ₜ₂, wherein the width of the first primary image IMG1ₜ₁ may be equal to umax, and the width of the second primary image IMG1ₜ₂ may also be equal to umax. The value umax may specify e.g. the number of pixels constituting a single horizontal row of the first primary image IMG1ₜ₁, and the value umax may specify e.g. the number of pixels constituting a single horizontal row of the second primary image IMG1ₜ₂.

The area of the first image portion POR1 may be e.g. smaller than 50% of the area of a digital image IMG1ₜ₁, which corresponds to the whole active area 101 of an image sensor 100. The area of the second image portion POR2 may be e.g. greater than 50% of the area of a digital image IMG1ₜ₁, which corresponds to the whole active area of an image sensor 100. In an embodiment, the area of the second image portion POR2 may substantially correspond to the whole active area 101 of the image sensor 100. In an embodiment, the second image portion POR2 may be smaller than the whole digital image IMG1ₜ₁ obtained the image sensor 100.

The second image portion POR2 may be displaced with respect to the first image portion POR1. The center of the second image portion POR2 may be displaced with respect to the center of the first image portion POR1.

In general, the width w_{IP2} of the second image portion POR2 may be different from the width w_{IP1} of the first image portion POR1, and/or the position u2,v2 of the second image portion POR2 may be different from the position u1,v1 of the first image portion POR1.

The aspect ratio of the first image portion POR1 may be substantially equal to the aspect ratio of the second image portion POR2.

Referring to FIG. 2c, the first sensor portion SPOR1 may have a width w_{SP1}, and the second sensor portion SPOR2 may have a width w_{SP2}.

The width w_{SP1} of the sensor portion SPOR1 may be determined according to the predefined zoom level ZLD. In an embodiment, the width w_{SP1} of the sensor portion SPOR1 may be determined according to the size of the known object as it appears in the digital image IMG1ₜ₁.

The second sensor portion SPOR2 may be substantially broader than the first sensor portion SPOR1. The relative width w_{SP2}/amax of the second sensor portion SPOR2 may be substantially greater than the relative width w_{SP1}/amax of the first sensor portion SPOR1. The width w_{SP2} of the second sensor portion SPOR2 may be substantially greater than the width w_{SP1} of the first sensor portion SPOR1. For example, the width w_{SP2} of the second sensor portion SPOR2 may be substantially greater than 50% of the width amax of the active area 101 of the image sensor 100, and the width w_{SP1} of the first sensor portion SPOR1 may be substantially smaller than 50% of the width amax of the active area 101. In an embodiment, the second sensor portion SPOR2 may cover substantially the whole active area 101 of the image sensor 100.

The second sensor portion SPOR2 may be displaced with respect to the first sensor portion SPOR1. The center of the second sensor portion SPOR2 may be displaced with respect to the center of the first sensor portion SPOR1.

In general, the width w_{SP2} of the second sensor portion SPOR2 may be different from the width w_{SP1} of the first sensor portion SPOR1, and/or the position a2,b2 of the second sensor portion SPOR2 may be different from the position a1,b1 of the first sensor portion SPOR1.

The size of the sensor portion SPOR1 may be determined according to the predefined zoom level ZLD. In an embodiment, the size of the sensor portion SPOR1 may be determined according to the size of the known object as it appears in the digital image IMG1ₜ₁. The area of the first sensor portion SPOR1 may be e.g. smaller than 50% of the area of the active area 101. The area of the second sensor portion SPOR2 may be e.g. greater than 50% of the area of the active area 101. In an embodiment, the second sensor portion SPOR2 may cover substantially the whole active area 101 of the image sensor 100.

The aspect ratio of the first sensor portion SPOR1 may be substantially equal to the aspect ratio of the second sensor portion SPOR2.

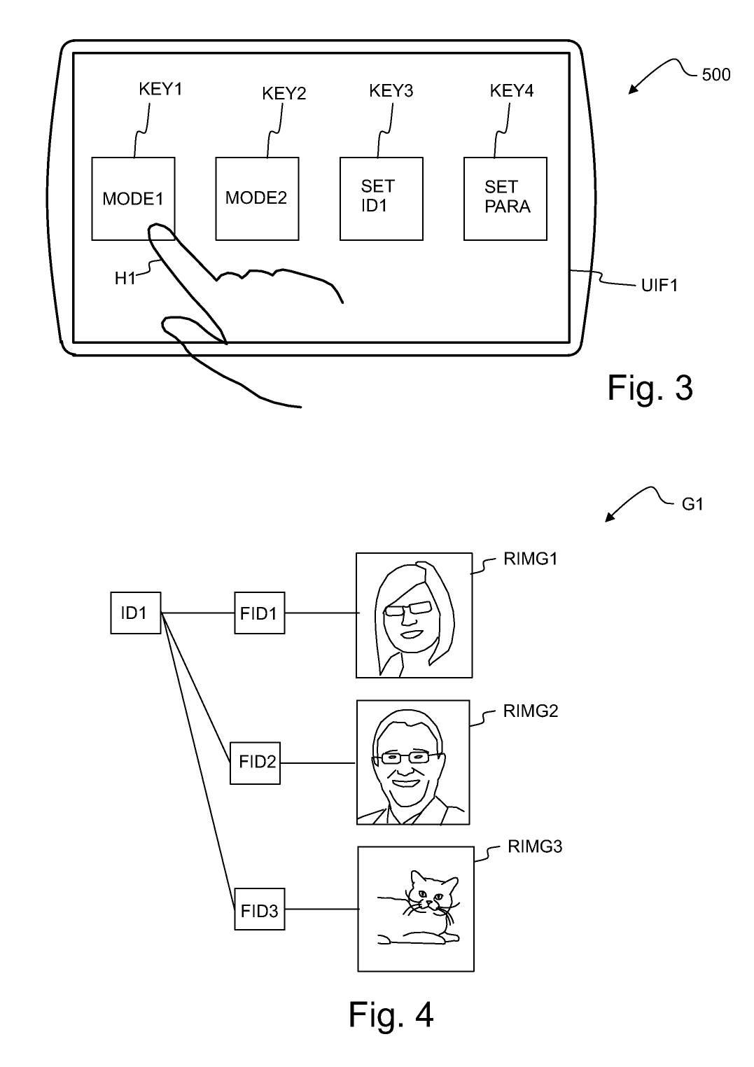

Referring to FIG. 3, forming the video sequence VID1 according to the first image portion POR1 and the second image portion POR2 may be enabled and/or disabled by using a user interface UIF1. The apparatus 500 may have a first operating mode MODE1, where the video sequence VID1 is formed according to the first image portion POR1 and the second image portion POR2. The first operating mode MODE1 may be selected e.g. by touching a key KEY1. When the operating mode MOD1 has been selected, the apparatus 500 may be configured to form the video sequence VID1 according to the video script SCRIPT1.

The apparatus 500 may optionally have a second operating mode MODE2 where image portions for the video sequence VID1 are selected in the conventional way by manually changing the direction of a camera and by manually adjusting the zoom value. The second operating mode MODE2 may be called e.g. a manual operating mode. The user may select the second operating mode MODE2 e.g. by touching a key KEY2.

The user may identify a person by inputting an identifier ID1. The identifier may be user-selectable. The identifier ID1 may comprise e.g. the name of a person or a personal identification number. The user of the apparatus 500 may have already identified himself at an earlier stage, and the default identification code ID1 may be the identification code of the user. However, the identifier ID1 may also be the identifier ID1 of another person, which is different from the user. Inputting the identifier ID1 may be started e.g. by touching the key KEY3. Inputting operating parameters may be started e.g. by touching a key KEY4.

Referring to FIG. 4, the identifier ID1 may be associated with one or more objects, which in turn may be represented by object codes FID1, FID2, FID3. The objects may be “objects of interest” to the person having the identifier ID1. The objects of interest may be e.g. “friends” of the person having the identifier ID1. In an embodiment, all objects are human beings. In an embodiment, an object of interest may also be a non-human object, e.g. an animal or a motorcycle.

The identifier ID1 may be associated with one or more object codes FID1, FID2, FID3. Each object code FID1, FID2, FID3 may be associated with reference image data RIMG1 RIMG2, RIMG3. The identification code ID1, the one or more object codes FID1, FID2, FID3, and the reference image data RIMG1, RIMG2, RIMG3 may together form a graph G1. The graph G1 may be stored in a memory. In particular, an object code FID1, FID2, FID3 may comprise the name of a person. The graph G1 may be received e.g. from a social networking service (e.g. the service provided under the trade name “Facebook”).

The reference image data RIMG, RIMG2, RIMG3 may comprise an actual digital image of an object. The reference image data RIMG1 RIMG2, RIMG3 may comprise compressed data relevant for image recognition.

The user of the apparatus 500 may create a video script SCRIPT1 for a video sequence e.g. by selecting a first zoom level, a second zoom level, and a timing scheme.

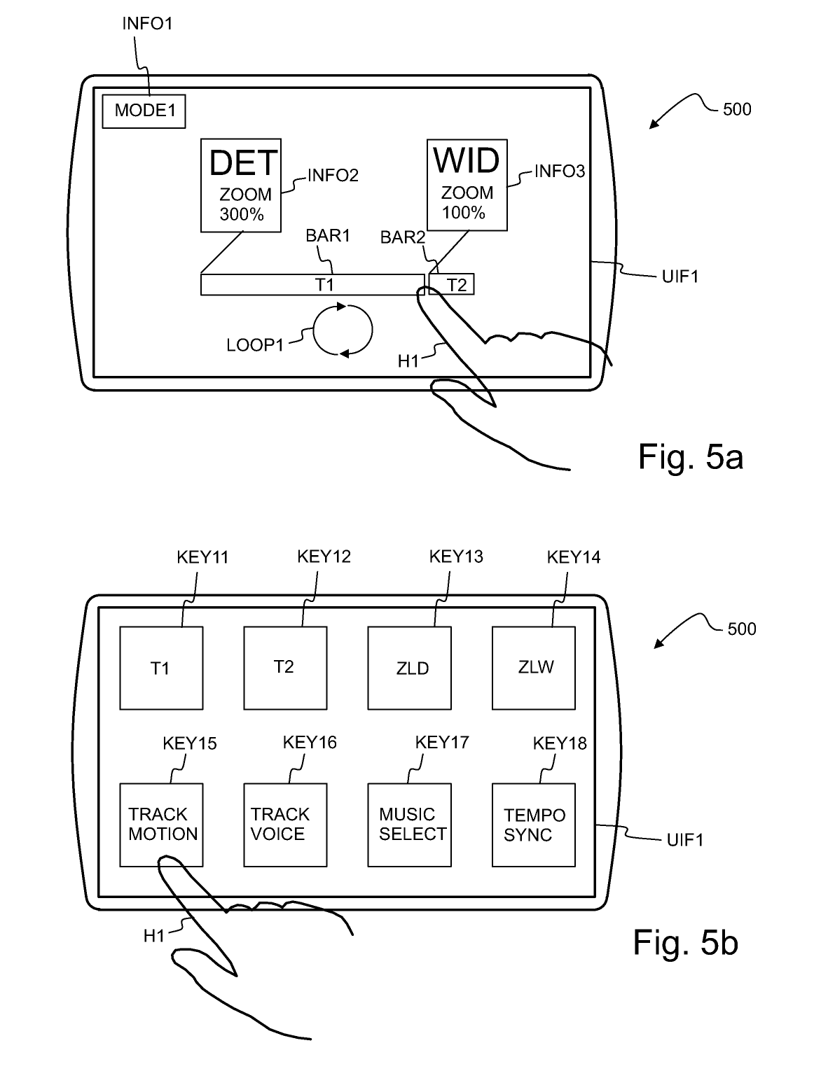

Referring to FIG. 5a, parameters for creating a video sequence VID1 may be displayed graphically.

Information INFO1 may indicate that the apparatus 500 is set to operate in the operating mode MODE1. Information INFO2 may indicate e.g. that a close up shot S1 has a first zoom level ZLD (e.g. 300%). Information INFO3 may indicate e.g. that a wide angle shots S2 has a second zoom level ZLW (e.g. 100%). The duration T1 of a first shot may be indicated by the length of a first bar BAR1. The duration T2 of a second shot may be indicated by the length of a second bar BAR2. The duration T1 of the first shot may be e.g. in the range of 1 s to 30 s, and the duration T2 of the second shot may be e.g. in the range of 1 s to 30 s. The user may adjust the duration T1 and/or T2 e.g. by sliding a finger H1 in the vicinity of an end of a bar BAR1, BAR2.

A loop symbol LOOP1 may be displayed to indicate that the combination of a close-up shot S1 and a wide angle shot S2 may be repeated several times.

Referring to FIG. 5b, operating parameters for forming the video sequence VID1 may be adjusted by using the user interface UIF1. The user may define e.g. the duration T1 of a close-up shot S1, the duration T2 of a wide-angle shot S2, the zoom level ZLD of the close-up shot S1, and/or the zoom level ZLW of the wide-angle shot S2.

The durations T1, T2 may define a timing scheme of the video script SCRIPT1 so that the duration of a first video shot S1 may be equal to the period T1, and the duration of a second video shot S2 may be equal to the period T2. In other words, the timing of the video shots S1, S2 may be determined by a timer. In an embodiment, the period T1 may be randomly varied within a first range, and the period T2 may be randomly varied within a second range in order to avoid monotonous impression.

Default duration T1 of the close-up shot S1 may be set e.g. by touching the key KEY11. Default duration T2 of the wide-angle shot S2 may be set e.g. by touching the key KEY12. Zoom level ZLD of the close-up shot S1 may be set e.g. by touching the key KEY13. Zoom level ZLW of the wide-angle shot S2 may be set e.g. by touching the key KEY14.

The timing of the video shots S1, S2 may also be based on movement detection. The apparatus 500 may have an operating mode, where the timing scheme determined by the periods T1, T2 is temporarily replaced with motion-based timing when analysis of primary image data SDATA1 indicates motion. The apparatus 500 may be arranged to start forming a close-up shot S1 of the known object when the known object is detected to move. The apparatus 500 may be arranged to start forming a wide-angle shot S2 when another object is detected to move. When no movement is detected, the close-up shots S1 and the wide-angle shots S2 may alternate according to the predetermined period lengths T1, T2. Movement detection may be enabled e.g. by touching a key KEY15.

The video sequence VID1 may also be formed based on voice detection. The timing scheme determined by the periods T1, T2 may be temporarily replaced when a sound is detected. The apparatus may comprise a microphone array arranged to determine the location of the source of an audio signal. The apparatus 500 may be arranged to start forming a close-up shot S1 of a known object when said known object is detected emit sound. The apparatus 500 may be arranged to start forming a wide-angle shot S2 when another object is detected to emit sound. When no sounds are detected, the close-up shots and the wide-angle shots may alternate according to the predetermined period lengths T1, T2. Voice detection may be enabled e.g. by touching a key KEY16.

In an embodiment, a piece of music may be incorporated in the video sequence VID1. A music selection dialog may be started e.g. by touching a key KEY17.

In an embodiment, selection of the piece of music may be facilitated e.g. by using a social networking service. One or more pieces of music may be associated with the person having the identification code ID1, e.g. by using the social network service. A search in the social network service may provide one or more candidate pieces of music, which are associated with the person having the identification code ID1. The user may select one of the candidate pieces to be incorporated in the video sequence VID1. The names of the candidate pieces may be displayed on a screen. The candidate pieces may be reproduced via a speaker. One of the candidate pieces of music may be selected and added as a soundtrack to the video sequence VID1. The apparatus 500 may automatically e.g. (randomly or according to alphabetical order) select one of the candidate pieces and add it to the video sequence VID1.

In an embodiment, the durations T1, T2 may be synchronized to an audio signal associated with the primary image data SDATA1. This operating mode may be enabled e.g. by touching a key KEY18. The audio signal may be captured e.g. by a microphone simultaneously when the primary image data is captured by the image sensor 100. The audio signal may represent music, which has a certain tempo (e.g. in the range of 40 to 240 beats per minute). The durations T1, T2 of the video shots S1, S2 may be synchronized to the tempo of the audio signal. In an embodiment, a portable device 500 may comprise the image sensor 100 and a microphone, wherein the image sensor 100 may be configured to provide the primary image data SDATA1, and the microphone may be arranged to provide the audio signal associated with the primary image data SDATA1

A switching pattern for generating the video sequence (video mix) from the preliminary image data may be generated e.g. by using face detection and/or by using analysis of the tempo of an audio scene (music).

In an embodiment, the video sequence VID1 may be formed from primary image data based on analysis of the audio scene tempo. If no rhythmic audio scene is detected, the apparatus may suggest a piece of music selected from a collection associated with the identifier ID1.

In an embodiment, the apparatus may be arranged to determine timing of the different video shots based on analysis of the ambient audio scene associated with the primary image data.

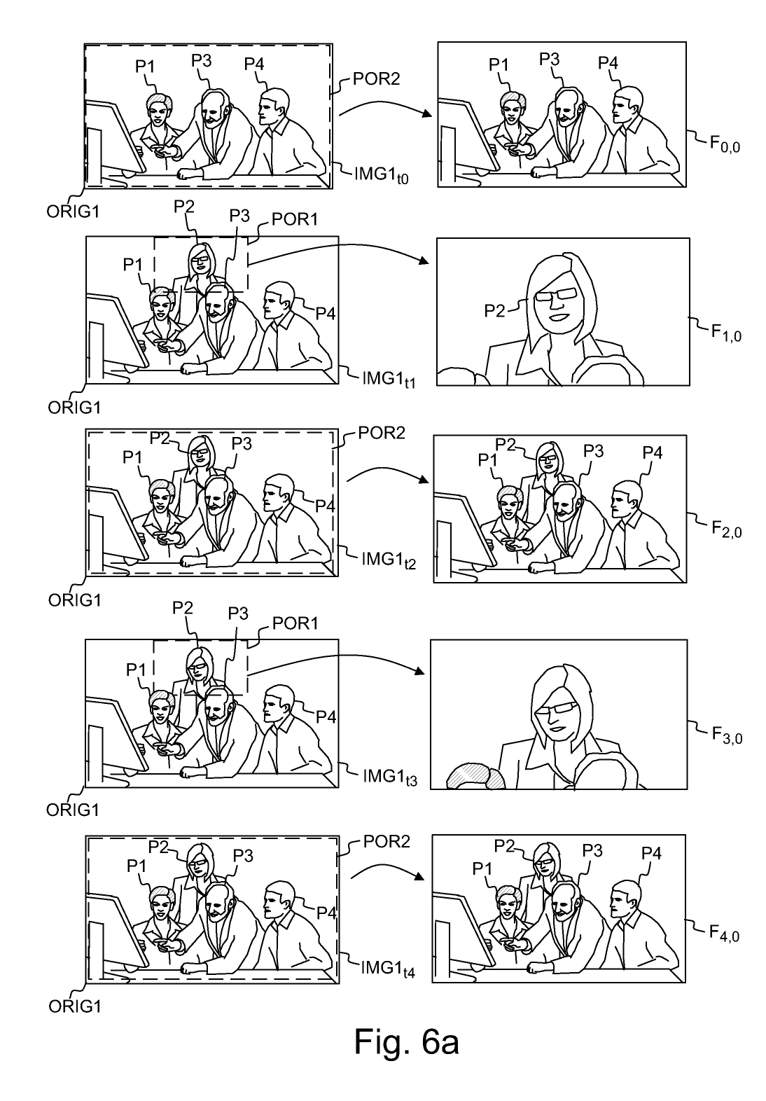

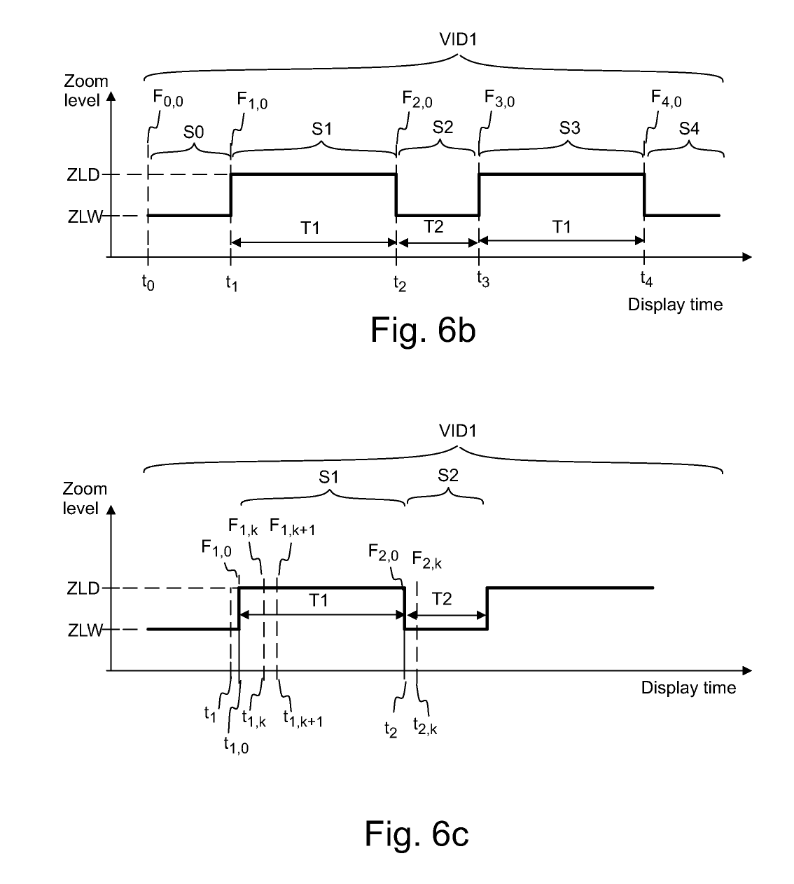

FIG. 6a shows, by way of example, forming image frames F_{0,0}, F_{1,0}, F_{2,0}, F_{3,0}, F_{4,0}, which may be incorporated in video sequence VID1.

Primary images IMG1ₜ₀, IMG1ₜ₁, IMG1ₜ₂, IMG1ₜ₃, IMG1ₜ₄ may be formed from Primary image data SDATA1. The primary images IMG1ₜ₀, IMG1ₜ₁, IMG1ₜ₂, IMG1ₜ₃, IMG1ₜ₄ may be associated with consecutive times t₀, t₁, t₂, t₃, t₄. In particular, the primary images IMG1ₜ₀, IMG1ₜ₁, IMG1ₜ₂, IMG1ₜ₃, IMG1ₜ₄ may be captured by an image sensor 100 at consecutive times t₀, t₁, t₂, t₃, t₄.

The primary images IMG1ₜ₀, IMG1ₜ₁, IMG1ₜ₂, IMG1ₜ₃, IMG1ₜ₄ may show e.g. a group of persons P1, P2, P3, P4. The person P1 may be e.g. a woman with dark hair. The person P2 may be e.g. a woman with glasses and blond hair. The person P3 may be e.g. a man with a beard. The person P4 may be e.g. a man without a beard.

The primary image data SDATA1 may comprise an image IMG1ₜ₀ at the time t₀. None of the faces of the image IMG1ₜ₀ matches with a reference image RIMG1 RIMG2, RIMG3 of FIG. 4. The apparatus 500 may determine that known faces are not detected, and a video shot S0 of the video sequence VID1 may be formed as a wide angle shot according to the image portion POR2. The width of the image portion POR2 may be determined e.g. according to the zoom level ZLW shown in FIG. 5b.

Comparison of the primary image IMG1ₜ₀ with reference image data may reveal that the primary image IMG1ₜ₀ does not contain a sub-image, which matches with the reference image data RIMG1, RIMG2, RIMG3 associated with the identifier ID1. The apparatus 500 may be arranged to form an image frame F_{0,0} from the primary image IMG1ₜ₀ according to the second image portion POR2. The image frame F_{0,0} may represent a general view of the event EVE1 at the time t₀. The image frame F_{0,0} may be included in a first shot of the video sequence VID1.

In an embodiment, the first video shot S0 may be formed as a wide angle shot according to the image portion POR2 until a known face is recognized.

The apparatus 500 may be configured to determine whether a face defined by a reference image RIMG1 appears in an image IMG1. The apparatus 500 may comprise one or more data processors CNT1 configured to carry out a face recognition algorithm. In particular, the analysis unit 450 shown in FIGS. 1a and 1b may be configured to determine whether a face defined by a reference image RIMG1 appears in an image IMG1.

The identification code ID1 provided by the user may be associated with one or more reference images RIMG1 RIMG2, RIMG3 according to FIG. 4. When the apparatus 500 detects that a face defined by a reference image RIMG1 also appears in an image IMG1 of the primary image data stream, the apparatus 500 may detect the position of the face in the image IMG1. The apparatus 500 may determine the position u1,v1 and the width of an image portion POR1 according to the position of a known (i.e. recognized) face. The apparatus 500 may determine framing of a video shot based on the position of the known face.

Comparison of the primary image IMG1ₜ₁ with reference image data may reveal that the primary image IMG1ₜ₁ contains a sub-image P2, which matches with the reference image data RIMG1 associated with the identifier ID1. The apparatus 500 may be arranged to form an image frame F_{1,0} from the primary image IMG1ₜ₁ according to the first image portion POR1. The image frame F_{1,0} may represent a close-up view of the person P2 at the time t₁. The image frame F_{1,0} may be included in a second shot of the video sequence VID1. The second shot may be appended to the first shot.

The image frame F_{1,0} may be formed from the primary image data SDATA1 according to the first image portion POR1. The image frame F_{1,0} may be formed from the primary image data SDATA1, which is obtained from an image sensor 100 near the time t₁. The image frame F_{1,0} does not need to be formed from the very same image IMG1ₜ₁, which was used for finding the known face of the person P2.

Comparison of the primary image IMG1ₜ₂ with reference image data may reveal that the primary image IMG1ₜ₂ still contains a sub-image P2, which matches with the reference image data RIMG1 associated with the identifier ID1. However, after the predetermined time period T1 has elapsed, the apparatus 500 may be arranged to form an image frame F_{2,0} from the primary image IMG1ₜ₂ according to the second image portion POR2. The image frame F_{2,0} may represent a general view of the event EVE1 at the time t₂. The image frame F_{2,0} may be included in a third shot of the video sequence VID1. The third shot may be appended to the second shot. Comparison of the primary image IMG1ₜ₃ with reference image data may reveal that the primary image IMG1ₜ₃ still contains a sub-image P2, which matches with the reference image data RIMG1 associated with the identifier ID1. After the predetermined time period T2 has elapsed, the apparatus 500 may be arranged to form an image frame F_{3,0} from the primary image IMG1ₜ₃ according to the first image portion POR1. The image frame F_{3,0} may represent a close-up view of the person P2 at the time t₃. The image frame F_{3,0} may be included in a fourth shot of the video sequence VID1. The fourth shot may be appended to the third shot.

Comparison of the primary image IMG1ₜ₄ with reference image data may reveal that the primary image IMG1ₜ₄ still contains a sub-image P2, which matches with the reference image data RIMG1 associated with the identifier ID1. After the predetermined time period T1 has elapsed, the apparatus 500 may be arranged to form an image frame F_{4,0} from the primary image IMG1ₜ₄ according to the first image portion POR2. The image frame F_{4,0} may represent a general view of the event EVE1 at the time t₄. The image frame F_{4,0} may be included in a fifth shot of the video sequence VID1. The fifth shot may be appended to the fourth shot.

Providing the video sequence VID1 may comprise:
receiving an identifier ID1,
receiving reference image data RIMG1 associated with the identifier ID1,
obtaining primary image data SDATA1,
forming a first primary image IMG1ₜ₁ from the primary image data SDATA1,
determining whether a sub-image P2 of the first primary image IMG1ₜ₁ is a known sub-image by comparing the first primary image IMG1ₜ₁ with the reference image data RIMG1,
determining the position u1,v1 of a first image portion POR1 based on the position of the known sub-image P2 in the first primary image IMG1ₜ₁,
forming a first image frame F_{1,0} from the primary image data SDATA1 according to the position u1,v1 of the first image portion POR1,
forming a second image frame F_{2,0} from the primary image data SDATA1 according to the position u2,v2 of a second image portion POR2, wherein the relative width w_{IP2}/umax of the second image portion POR2 is greater than the relative width w_{IP1}/umax of the first image portion POR2, and
forming a video sequence (VID1), which comprises a first video shot S1 and a second video shot S2, wherein the first video shot S1 comprises the first image frame F_{1,0}, and the second video shot S2 comprises the second image frame F_{2,0}.

When the primary image data SDATA1 is obtained from the image sensor 100, providing the video sequence VID1 may comprise:
obtaining reference image data RIMG1 associated with an identifier ID1,
obtaining primary image data SDATA1,
forming a first primary image IMG1ₜ₁ from the primary image data SDATA1,
determining whether a sub-image P2 of the first primary image IMG1ₜ₁ is a known sub-image by comparing the first primary image IMG1ₜ₁ with the reference image data RIMG1,
determining the position a1,b1 of a first sensor portion SPOR1 based on the position of the known sub-image P2 in the first primary image IMG1ₜ₁,
forming a first image frame F_{1,0} from the primary image data obtained from the first sensor portion,
forming a second image frame F_{2,0} from the primary image data SDATA1 obtained from a second sensor portion SPOR2, wherein the width w_{SP2} of the second sensor portion SPOR2 is greater than the width w_{SP1} of the first sensor portion SPOR1, and
forming a video sequence VID1, which comprises a first video shot S1 and a second video shot S2, wherein the first video shot S1 comprises the first image frame F_{1,0}, and the second video shot S2 comprises the second image frame F_{2,0}.

The primary image data may comprise an image IMG1ₜ₁ at the time t₁. The apparatus 500 may detect that the face of the person P2 matches with the reference image RIMG. The apparatus 500 may determine that the face of the person P2 is a known face. A video shot S1 of the video sequence VID1 may be formed as a close-up shot according to the image portion POR1. The width of the image portion POR1 may be determined e.g. according to the zoom level ZLD shown in FIG. 5b. The video shot S1 may be close-up shot of the known face P2.

In an embodiment, the maximum duration of the close-up video shot S1 may be equal to T1 (see FIGS. 5a and 5b). The time period T1 may be e.g. 15 s. After the time period T1 has elapsed, the apparatus 500 may form the next video shot S2 according to the image portion POR2 again. A video shot S2 of the video sequence VID1 may be formed as a wide angle shot according to the image portion POR2.

In an embodiment, the person P2 may disappear before the time period T1 has elapsed, and the apparatus 500 may start to form the next video shot S2 as a wide angle image according to the image portion POR2 when disappearance of the person P2 has been detected.

The duration of the video shot S2 may be equal to the time period T2 if the person P2 still appears in the image IMG1ₜ₃ after the time period T2 has elapsed. If the person P2 appears in the image IMG1ₜ₃, a video shot S3 of the video sequence VID1 may be formed as a close-up shot according to the image portion POR1.

After the time period T1 has elapsed or when the person P2 disappears, the apparatus 500 may form the next video shot S4 according to the image portion POR2 again.

In an embodiment, a first video shot of a video sequence may represent a wide angle (panorama) view. When the presence of a known face is detected, the first video shot may be switched to a second video shot, which may represent a close-up shot of the known face. When the face disappears, the second video shot may be switched to a third video shot, which represents the wide angle view, again. The video shots may be temporally combined to form the video sequence.

In an embodiment, a first video shot of a video sequence may represent a wide angle (panorama) view. When the presence of a known face is detected, the first video shot may be switched to a second video shot, which may represent a close-up shot of the known face. After the time period T1 has elapsed, the second video shot may be switched to a third video shot even if the known face would still appear. The third video shot may represent the wide angle view.

In an embodiment, if the presence of a known face is not detected, the apparatus 500 may seek for any face appearing in the primary image data. The apparatus 500 may be configured to form a first video shot, which shows a close-up view of a face, which is not a known face. If several unknown faces are present simultaneously, the apparatus 500 may e.g. randomly select one of the faces to be shown in the first video shot. When a known face appears, the apparatus 500 may start to form a second video shot, which shows a close-up view of the known face.

The sub-image of the person P2 appearing in the image IMG1ₜ₃ may deviate from the reference image data RIMG1. For example, the person might have turned her head so that she cannot be reliably recognized only by comparing the image IMG1ₜ₃ with the reference image data RIMG1. However, the apparatus 500 may be configured to utilize further information determined from other images IMG1ₜ₁, IMG1ₜ₂ associated with a time t₁, t₂ before and/or after the time t₃. Recognizing a face of person from a first image IMG1ₜ₁ associated with a first time t₁ may be assisted by recognizing the face of said person from a second image IMG1ₜ₂ associated with a second time t₂.

FIG. 6b shows, by way of example, timing and zoom levels for the video sequence of FIG. 6a. S0 may denote the first video shot of the video sequence VID1, wherein the video shot S0 may comprise the image frame F_{0,0}. S1 may denote the second video shot of the video sequence VID1, wherein the video shot S1 may comprise the image frame F_{1,0}. S2 may denote the third video shot of the video sequence VID1, wherein the video shot S2 may comprise the image frame F_{2,0}. S3 may denote the fourth video shot of the video sequence VID1, wherein the video shot S3 may comprise the image frame F_{3,0}. S4 may denote the fifth video shot of the video sequence VID1, wherein the video shot S4 may comprise the image frame F_{4,0}.

FIG. 6c shows a more general timing scheme for video shots S1, S2 of a video sequence VID1. When the presence of a known object is detected from a primary image IMG1ₜ₁ associated with time t₁, then the start time t_{1,0} of the first video shot S1 may also be delayed with respect to the time t₁. The time t_{1,0} of the first image frame F_{1,0} of the first video shot S1 may be delayed with respect to the time t₁. k may denote an integer, which is greater than or equal to one. The k^{th} image frame of the video shot S1 may have a time t_{1,k}. The next image frame F_{1,k+1} of the video shot S1 may have a time t_{1,k+1}. The second video shot S2 may be started at a time t_{2,0}. An image frame F_{2,k} of the second video shot S2 may have a time t_{2,k}. The image frames F_{1,0}, F_{1,k}, F_{1,k+1} of the first video shot S1 may be formed according to the position of the image portion POR1. The image frames F_{2,0}, F_{2,k}, F_{2,k+1} of the second video shot S2 may be formed according to the image portion POR2.

When the video sequence VID1 is displayed at a later stage, the order of the image frames may be determined according to a display order. When the video sequence VID1 is displayed at a later stage, the timing of each image frame may be determined according to a display time of said image frame. The video sequence VID1 may contain data, which specifies that the image frame F_{1,k+1} should be displayed after the image frames F_{1,0} and F_{1,k}. The video sequence VID1 may contain data, which specifies that the image frame F_{2,k} should be displayed after the image frames F_{1,0}, F_{1,k}, F_{1,k+1}. The video sequence VID1 may contain data, which specifies that the image frame F_{1,0} has a display time t_{1,0}, the frame F_{1,k} has a display time t_{1,k}, the frame F_{1,k+1} has a display time t_{1,k+1}, the frame F_{2,0}, has a display time t_{2,0}, and the frame F_{2,k} has a display time t_{2,k}.

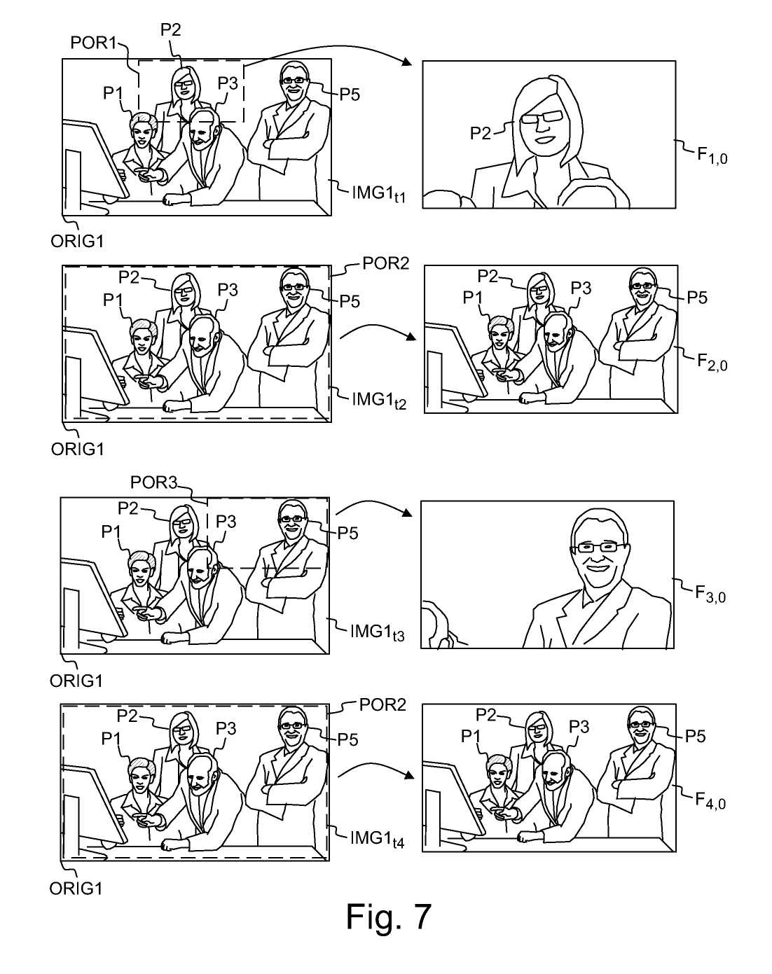

FIG. 7 shows by way of example, forming a video sequence VID1 in a situation where the primary image data SDATA1 comprises two or more known faces. FIG. 7 shows forming image frames F_{1,0}, F_{2,0}, F_{3,0}, F_{4,0}, which may be incorporated in video sequence VID1.

The face of the person P2 may match with the reference image RIMG1 associated with the identifier ID1. The face of the person P5 may match with the reference image RIMG2 associated with the identifier ID1. The face of the person P1 and the face of the person P3 do not match with any of the reference images RIMG1, RIMG2, RIMG3 associated with the identifier ID1.

Primary images IMG1ₜ₁, IMG1ₜ₂, IMG1ₜ₃, IMG1ₜ₄ may be formed from primary image data SDATA1. In particular, the primary image data SDATA1 may comprise the primary images IMG1ₜ₁, IMG1ₜ₂, IMG1ₜ₃, IMG1ₜ₄. The primary images IMG1ₜ₁, IMG1ₜ₂, IMG1ₜ₃, IMG1ₜ₄ may be associated with consecutive times t₁, t₂, t₃, t₄. In particular, the primary images IMG1ₜ₁, IMG1ₜ₂, IMG1ₜ₃, IMG1ₜ₄ may be captured by an image sensor 100 at consecutive times t₁, t₂, t₃, t₄.

The apparatus 500 may be configured to execute a face recognition algorithm in order to determine whether the image IMG1ₜ₁ comprises a known face. The apparatus 500 may compare the image IMG1ₜ₁ with the reference image RIMG1 in order to detect whether the image IMG1ₜ₁ comprises a face, which matches the reference image RIMG1. The apparatus 500 may compare the image IMG1ₜ₁ with the reference image RIMG2 in order to detect whether the image IMG1ₜ₁ comprises a face, which matches the reference image RIMG2.

The apparatus 500 may determine e.g. that the face of the person P2 matches with the reference image RIMG1, and that the face of the person P5 matches with the reference image RIMG2. Thus, the person P2 may be classified to be an object of interest, and the person P5 may also be classified to be an object of interest.

Comparison of the primary image IMG1ₜ₁ with reference image data may reveal that the primary image IMG1ₜ₁ contains a sub-image P2, which matches with the reference image data RIMG1 associated with the identifier ID1. Comparison of the primary image IMG1ₜ₁ with reference image data may also reveal that the primary image IMG1ₜ₁ contains a sub-image P5, which matches with the reference image data RIMG2 associated with the identifier ID1.

Now, when the image IMG1ₜ₁ comprises two or more known faces, the apparatus 500 may e.g. randomly select which one of the faces will appear in the first close-up shot. Alternatively, the apparatus 500 may select a known face, e.g. according to an alphabetical list or according to another criterion. The apparatus 500 may determine the position of the image portion POR1 e.g. according to the position of the recognized face of the person P2.

The apparatus 500 may be arranged to form an image frame F_{1,0} from the primary image IMG1ₜ₁ according to the first image portion POR1. The image frame F_{1,0} may represent a close-up view of the person P2 at the time t₁. The image frame F_{1,0} may be included in a first shot of the video sequence VID1.

Comparison of the primary image IMG1ₜ₂ with reference image data may reveal that the primary image IMG1ₜ₂ still contains a sub-image P2, which matches with the reference image data RIMG1 associated with the identifier ID1. After the predetermined time period T1 has elapsed, the apparatus 500 may be arranged to form an image frame F_{2,0} from the primary image IMG1ₜ₂ according to the second image portion POR2. The image frame F_{2,0} may represent a general view of the event EVE1 at the time t₂. The image frame F_{2,0} may be included in a second shot of the video sequence VID1. The second shot may be appended to the first shot.

Comparison of the primary image IMG1ₜ₃ with reference image data may reveal that the primary image IMG1ₜ₃ still contains a sub-image P5, which matches with the reference image data RIMG2 associated with the identifier ID1. After the predetermined time period T2 has elapsed, the apparatus 500 may be arranged to use a third image portion POR3. The position of the image portion POR3 may be determined according to the position of the second known face P5 appearing in the primary image IMG1ₜ₃. The apparatus 500 may be arranged to form an image frame F_{3,0} from the primary image IMG1ₜ₃ according to the third image portion POR3. The image frame F_{3,0} may represent a close-up view of the second known person P5 at the time t₃. The image frame F_{3,0} may be included in a third shot of the video sequence VID1. The third shot may be appended to the second shot.

Comparison of the primary image IMG1ₜ₄ with reference image data may reveal that the primary image IMG1ₜ₄ still contains a sub-image P5, which matches with the reference image data RIMG2 associated with the identifier ID1. After the predetermined time period T1 has elapsed, the apparatus 500 may be arranged to form an image frame F_{4,0} from the primary image IMG1ₜ₄ according to the second image portion POR2. The image frame F_{4,0} may represent a general view of the event EVE1 at the time t₄. The image frame F_{4,0} may be included in a fourth shot of the video sequence VID1. The fourth shot may be appended to the third shot.

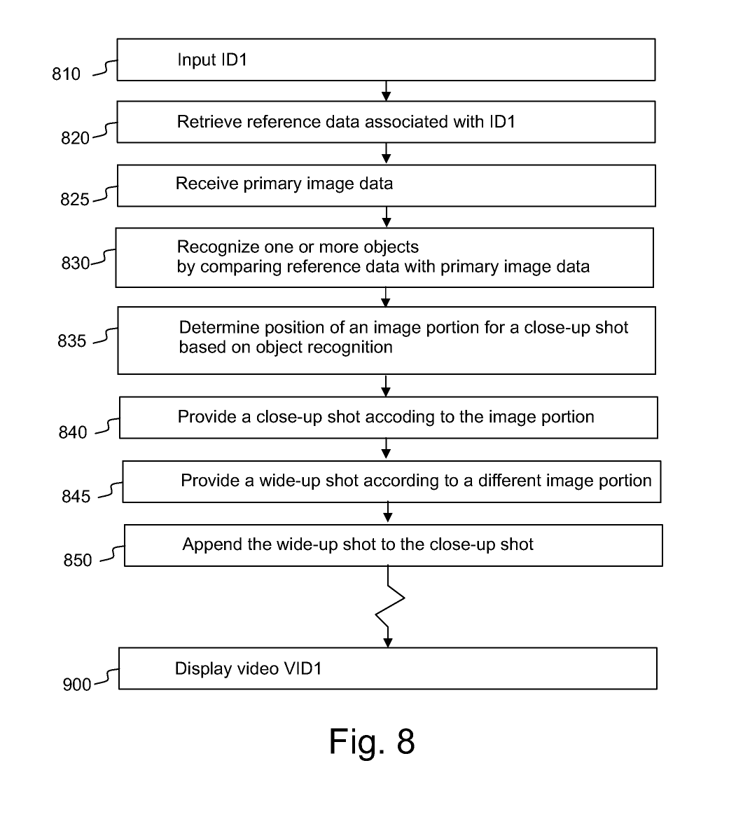

FIG. 8 shows method steps for forming a video sequence VID1, and for displaying the video sequence VID1. The video sequence VID1 may comprise a close-up shot and a wide-angle shot.

In step 810, the identifier ID1 may be provided.

In step 820, reference data RIMG1 associated with the identifier ID1 may be retrieved e.g. from a memory MEM5. Reference data RIMG1 associated with the identifier ID1 may be retrieved e.g. from a social networking service.

In step 825, primary image data SDATA1 may be provided. In particular, the primary image data SDATA1 may be obtained from an image sensor 100. The primary image data SDATA1 may be provided by exposing the image sensor 100 to the light received from one or more objects O1, 02, O3, O4.

In step 830, the primary image data SDATA1 may be analyzed in order to determine whether the primary image data SDATA1 contains a sub-image of an object of interest. In particular, the primary image data SDATA1 may be analyzed in order to determine whether the primary image data SDATA1 contains a face, which matches with the reference data RIMG1.

In step 835, the position u1,v1 of an image portion POR1 may be determined according to the position of a sub-image of an object of interest appearing in a primary image. The position u1,v1 of an image portion POR1 may be determined according to the position of the sub-image. An image frame F_{1,0} may be formed from primary image data according to the image portion POR1.

The image frame F_{1,0} may be formed from primary image data SDATA1, which has been provided by exposing the image sensor 100 to the light of an optical image IMG1 at the time t₁. The image frame F_{1,0} may represent the image area covered by the image portion POR1. Image data from pixels outside the portion POR1 may be discarded or included in the image frame F_{1,0} by using a relatively low number of bytes. In other words, the number of bytes used for storing sensor data from pixels outside the portion POR1 may be lower than the number of bytes used for storing sensor data from pixels inside the portion POR1.

In step 840, the apparatus 500 may form a close-up shot S1 by using image data obtained from the image portion POR1 such that the shot S1 comprises the image frame F_{1,0}. The duration of the close-up shot S1 may be determined e.g. by the time period T1.

In step 845, an image frame F_{2,0} may be formed by obtaining image data from the image portion POR2. The image frame F_{2,0} may be formed from primary image data SDATA1, which has been provided by exposing the image sensor 100 to the light of an optical image IMG1 at the time t₂. The apparatus 500 may form a wide angle shot S2 by obtaining image data from the image portion POR2 such that the shot S2 comprises the image frame F_{2,0}. The duration of the wide-angle shot S2 may be determined e.g. by the time period T2.

In step 850, the second video shot S2 may be appended to the first video shot S1. A video sequence VID1 comprising the first video shot S1 and the second video shot S2 may be stored in a memory and/or transmitted to a remote location.

In step 900, the video sequence VID1 comprising the first video shot S1 and the second video shot S2 may be displayed. The video sequence VID1 may be displayed during forming said video sequence VID1, immediately after it has been formed, or at a later stage.

At least one of the objects shown in the video sequence VID1 may be moving during recording the video sequence VID1. Displaying the image frames in the consecutive order may create an impression of a moving object.

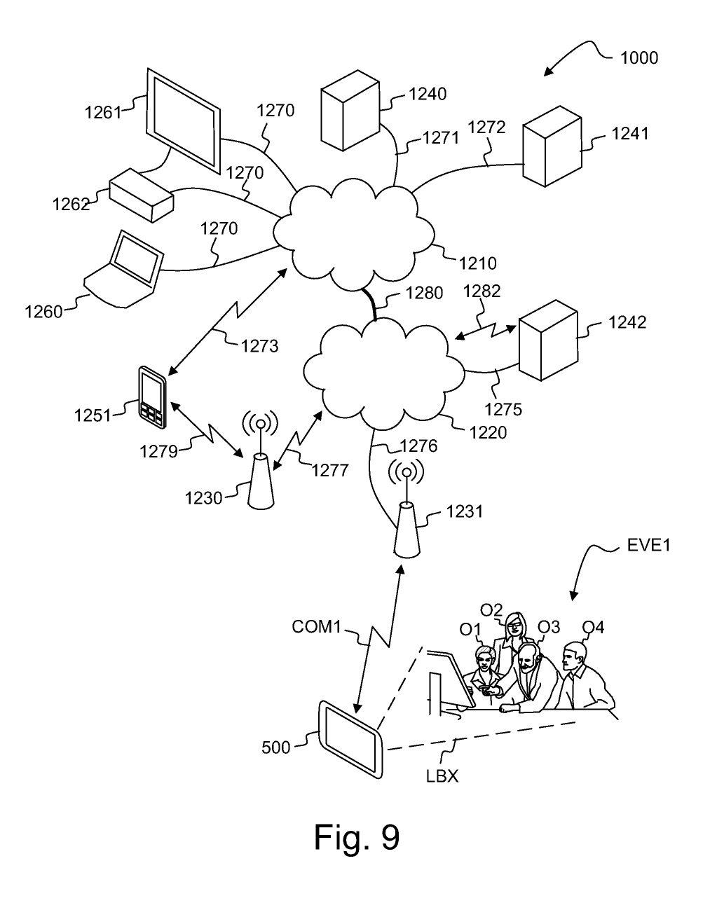

FIG. 9 shows, by way of example, a distributed system 1000 for capturing primary image data SDATA1, for storing reference data RIMG1, for forming a video sequence VID1 according to a script SCRIPT1, and for displaying the video sequence VID1. The system 1000 may comprise a plurality of devices arranged to communicate with each other.

The system 1000 may comprise a device 500. The device 500 may be portable. The device 500 may comprise one or more data processors configured to form a video sequence VID1 according to the script SCRIPT1. The device 500 may be a user device. The user device 500 may optionally comprise an image sensor 100 for providing primary image data SDATA1 associated with an event EVE1. The user device 500 may be camera. The image sensor 100 may receive light LBX reflected and/or emitted from the one or more objects O1, 02, O3, O4.

The system 1000 may comprise end-user devices such as one or more portable devices 500, mobile phones or smart phones 1251, Internet access devices (Internet tablets), personal computers 1260, a display or an image projector 1261 (e.g. a television), and/or a video player 1262. A mobile phone, a smart phone, an Internet access device, or a personal computer may comprise an image sensor 100 for providing primary image data SDATA1. A server, a mobile phone, a smart phone, an Internet access device, or a personal computer may be arranged to form a video sequence VID1 from the primary image data SDATA1 according to a script SCRIPT1. A mobile phone, a smart phone, an Internet access device, or a personal computer may comprise a user interface UIF1 for defining a script SCRIPT1 and/or for controlling forming the video sequence VID1.

Distribution and/or storing primary image data SDATA1, video scripts SCRIPT1, video sequences VID1, and individual image frames may be implemented in the network service framework with one or more servers 1240, 1241, 1242 and one or more user devices. As shown in the example of FIG. 9, the different devices of the system 1000 may be connected via a fixed network 1210 such as the Internet or a local area network (LAN). The devices may be connected via a mobile communication network 1220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks may be connected to each other by means of a communication interface 1280. A network (1210 and/or 1220) may comprise network elements such as routers and switches to handle data (not shown). A network may comprise communication interfaces such as one or more base stations 1230 and 1231 to provide access for the different devices to the network. The base stations 1230, 1231 may themselves be connected to the mobile communications network 1220 via a fixed connection 1276 and/or via a wireless connection 1277. There may be a number of servers connected to the network. For example, a server 1240 for providing a network service such as a social media service may be connected to the network 1210. A second server 1241 for providing a network service may be connected to the network 1210. A server 1242 for providing a network service may be connected to the mobile communications network 1220. Some of the above devices, for example the servers 1240, 1241, 1242 may be arranged such that they make up the Internet with the communication elements residing in the network 1210. The devices 500, 1251, 1260, 1261, 1262 can also be made of multiple parts. One or more devices may be connected to the networks 1210, 1220 via a wireless connection 1273. Communication COM1 between a device 500 and a second device of the system 1000 may be fixed and/or wireless. One or more devices may be connected to the networks 1210, 1220 via communication connections such as a fixed connection 1270, 1271, 1272 and 1280. One or more devices may be connected to the Internet via a wireless connection 1273. One or more devices may be connected to the mobile network 1220 via a fixed connection 1275. A device 500, 1251 may be connected to the mobile network 1220 via a wireless connection COM1, 1279 and/or 1282. The connections 1271 to 1282 may be implemented by means of communication interfaces at the respective ends of the communication connection. A user device 500, 1251 or 1260 may also act as web service server, just like the various network devices 1240, 1241 and 1242. The functions of this web service server may be distributed across multiple devices.

Application elements and libraries may be implemented as software components residing on one device. Alternatively, the software components may be distributed across several devices. The software components may be distributed across several devices so as to form a cloud.

The video sequence VID1 may be stored and/or communicated by using a data compression codec, e.g. by using H.264, WMV, DivX Pro Codec, or a future codec.

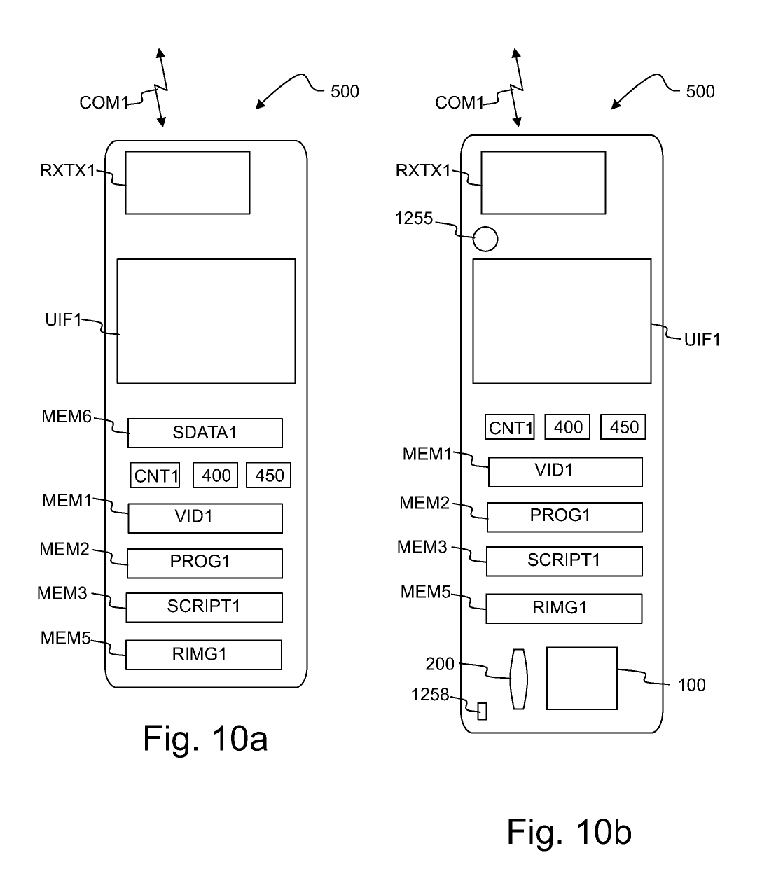

FIG. 10a shows a portable device 500, which may be configured to form the video sequence VID1 from primary image data SDATA1 according to a script SCRIPT1. The device 500 may be e.g. a mobile phone, a smartphone, a communicator, a portable computer, or a personal digital assistant (PDA). The device 500 may comprise a communication unit RXTX1, a user interface UIF1, a memory MEM6 for storing primary image data SDATA1, one or more processors CNT1, 400, 450, a memory MEM1 for storing the video sequence VID1, a memory MEM2 for storing computer program PROG1, a memory MEM3 for storing a video script SCRIPT1, and a memory for storing reference image data RIMG1. The device 500 may comprise a communication unit RXTX1 for transmitting data wirelessly e.g. to the Internet 1210, and/or to a mobile telephone network 1220. The units and functionalities of the device 500 may be implemented as described e.g. in the context of FIGS. 1a, 2b, 3, 4, 5a, 5b, 6a, 6b, 6c, 7, 8, and/or 9.

FIG. 10b shows a portable device 500, which further comprises an image sensor 100 and optics 200. The device 500 may be configured to form the video sequence VID1 from the primary image data SDATA1 obtained from the image sensor 100. The device 500 may be e.g. a camera. The device 500 may be e.g. a mobile phone, a smartphone, a communicator, a portable computer, or a personal digital assistant (PDA), which comprises a camera.

The device 500 may further comprise one or more microphones 1258 for converting sound waves into audio signals. The device 500 may further comprise one or more speakers 1255 for reproducing audio signals. A microphone 1258 may be used e.g. to implement a mobile phone functionality. A microphone 1258 may be used e.g. to record an audio signal associated with the primary image data SDATA1. The units and functionalities of the device 500 may be implemented e.g. as described in the context of FIGS. 1a, 1b, 2a, 2b, 2c, 3, 4, 5a, 5b, 6a, 6b, 6c, 7, 8, and/or 9.

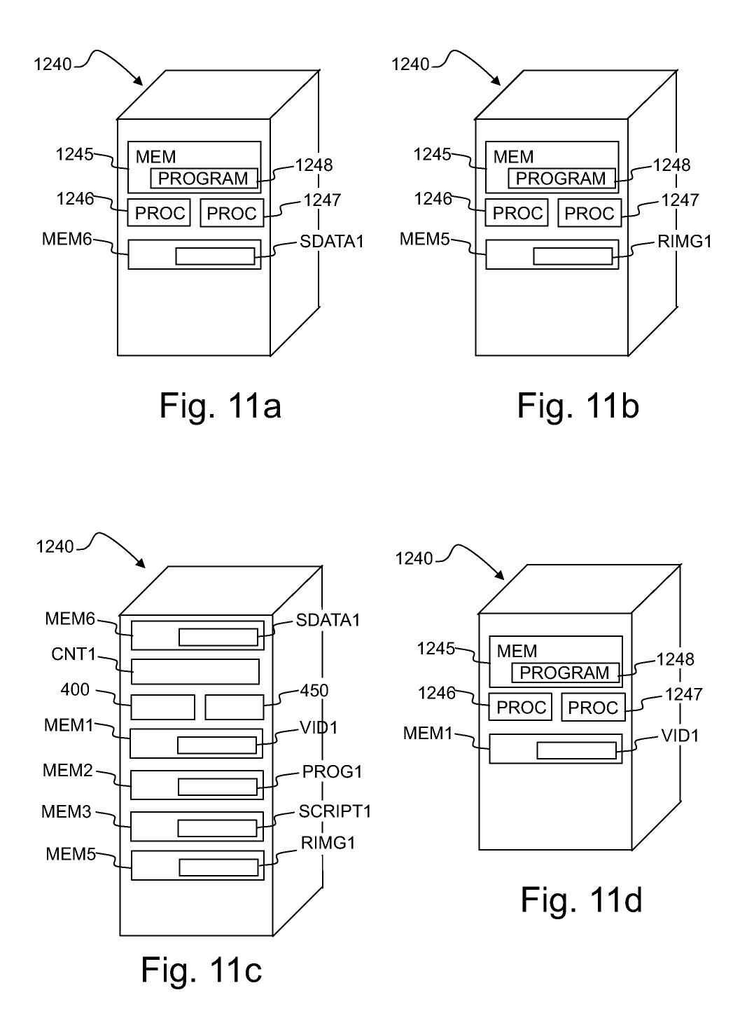

FIG. 11a shows a server 1240, which may comprise a memory 1245, one or more processors 1246, 1247, and computer program code 1248 residing in the memory 1245 for implementing, for example, a video distribution service and/or a social networking service. The video distribution service may be e.g. an internet television channel. The video distribution service may be provided e.g. under a trade name “Youtube”. One or more video sequences stored in the server 1240 may be used as primary image data SDATA for creating a video sequence VID1.

FIG. 11b shows a server 1240, which may comprise a memory 1245, one or more processors 1246, 1247, and computer program code 1248 residing in the memory 1245 for implementing, for example, a social networking service. The server 1240 may provide reference image data RIMG1 for creating a video sequence VID1.

FIG. 11c shows a server 1240, which may be configured to form the video sequence VID1 from primary image data SDATA1 according to a script SCRIPT1. The server 1240 may comprise a memory MEM6 for storing primary image data SDATA1, one or more processors CNT1, 400, 450, a memory MEM1 for storing the video sequence VID1, a memory MEM2 for storing computer program PROG1, a memory MEM3 for storing a video script SCRIPT1, and a memory for storing reference image data RIMG1.

FIG. 11d shows a server 1240, which may comprise a memory 1245, one or more processors 1246, 1247, and computer program code 1248 residing in the memory 1245 for implementing, for example, a video distribution service and/or a social networking service. The video distribution service may be e.g. an internet television channel. The video distribution service may be provided e.g. under a trade name “Youtube”.

Servers 1240, 1241, 1242 shown in FIG. 9 may comprise elements for employing functionality relevant to each server. A user device 500, 1251 or 1260 may also act as web service server, just like the various network devices 1240, 1241 and 1242. The functions of this web service server may be distributed across multiple devices.

The reference image data may be obtained from a social networking service. The social networking service may be provided e.g. under a trade name Facebook or Linkedin. A social networking service may be web-based online service, which may provide a platform for a first person to:
construct a public profile or a semi-public profile,
provide a first list of two or more other persons that the first person shares a connection with, and
view further list of connections of the other persons.

The social networking service may provide pictures of the other persons. The profile may contain information specifying e.g. age, location, and/or interests of the first person. The term public profile or a semi-public means that two or more other persons may view the profile of the first person and view the first list of connections. To protect user privacy, the social networks may have an access control to enable and/or disable viewing the profile of the first person and the first list of connections. The access control may utilize e.g. password.

In an embodiment, the user may adjust the zoom levels of the video shots and then start the recording. The apparatus may also be configured to track the instantaneous position of the known (recognized) object, when it is moving. The position of the image portion POR1 may be moved according to the position of the known object so that the sub-image of the known object may be kept within the first image portion POR1. Thus, the video shot may show a close-up view of the known object as long as it is in the field of view of the image sensor.

In an embodiment, a single camera device enabled with high resolution sensors can be used in unison with other similarly equipped camera devices to generate primary image data. A first mobile device having an image sensor and a second mobile device having an image sensor may collaboratively provide the primary image data. The devices may be connected in traditional client server manner, where the mobile devices act as the media capturing clients and a server may form the video sequence from the primary image data based on object recognition. One of the mobile devices may also be arranged to form the video sequence from the primary image data based on object recognition. Multiple devices may be connected to each other using peer-to-peer topology.

When using a touch screen, the user may input information by touching the touch screen with a touching member. The touching member may be e.g. a finger or a stylus. Touching the touch screen may refer to actual physical contact between the touching member and the screen. Touching the touch screen may also mean bringing the touching member close to the screen so that the distance between the finger H1 and the screen is smaller than a predetermined distance (e.g. smaller than 1% of the width of the touch screen).

For the person skilled in the art, it will be clear that modifications and variations of the devices and the methods according to the present invention are perceivable. The figures are schematic. The particular embodiments described above with reference to the accompanying drawings are illustrative only and not meant to limit the scope of the invention, which is defined by the appended claims.

1-57. (canceled)

58. A method, comprising:
obtaining reference image data associated with an identifier,
obtaining primary image data,
forming a first primary image from the primary image data,
determining whether a sub-image of the first primary image is a known sub-image by comparing the first primary image with the reference image data,
determining the position of a first image portion based on the position of the known sub-image in the first primary image,
forming a first image frame from the primary image data according to the position of the first image portion,
forming a second image frame from the primary image data according to the position of a second image portion, and
forming a video sequence, which comprises a first video shot and a second video shot, wherein the first video shot comprises the first image frame, and the second video shot comprises the second image frame.

59. The method of claim 58 wherein the first video shot is a close-up shot, and the second video shot is a wide-angle shot.

60. The method of claim 58 comprising retrieving the reference image data from a social networking service.

61. The method according to claim 58 comprising obtaining the primary image data from an image sensor.

62. The method according to claim 58 wherein the first image frame is formed from the primary image data obtained by exposing an image sensor to light at a first time, the second image frame is formed from the primary image data obtained by exposing the image sensor to light at a second time, and the primary image data is obtained from the image sensor substantially without moving the image sensor between the first time and the second time.

63. The method of claim 62 wherein the first image frame is formed mainly from the primary image data obtained from a first sensor portion of the image sensor, the second image frame is formed mainly from the primary image data obtained from a second sensor portion of the image sensor, and the width of the second sensor portion is larger than the width of the first sensor portion.

64. The method according to claim 58 wherein the duration of the first video shot is determined according to a predetermined time period.

65. The method according to claim 58 wherein timing of the end of the second video shot is determined according to a detected movement or a voice.

66. The method according to claim 58 wherein timing of the first video shot and timing of the second video shot are determined from the tempo of an audio signal.

67. The method of claim 66 wherein the audio signal is associated with the identifier by using information obtained from server, which is configured to implement a social networking service.

68. The method of claim 66 wherein a portable device comprises an image sensor and one or more microphones, wherein the first image frame is formed from the primary image data obtained from the image sensor, and the audio signal is captured by the one or more microphones.

69. An apparatus comprising at least one processor, a memory including computer program code, the memory and the computer program code configured to, with the at least one processor, cause the apparatus to perform at least the following:
obtain reference image data associated with an identifier,
obtain primary image data,
form a first primary image from the primary image data,
determine whether a sub-image of the first primary image is a known sub-image by comparing the first primary image with the reference image data,
determine the position of a first image portion based on the position of the known sub-image in the first primary image,
form a first image frame from the primary image data according to the position of the first image portion,
form a second image frame from the primary image data according to the position of a second image portion,
store and/or transmit a video sequence, which comprises a first video shot and a second video shot, wherein the first video shot comprises the first image frame, and the second video shot comprises the second image frame.

70. The apparatus of claim 69 wherein the first video shot is a close-up shot, and the second video shot is a wide-angle shot.

71. The apparatus of claim 69, wherein the reference image data is retrieved from a social networking service.

72. The apparatus according to claim 69, wherein the primary image data is obtained from an image sensor.

73. The apparatus according to claim 69 wherein the first image frame is formed from the primary image data obtained by exposing an image sensor to light at a first time, the second image frame is formed from the primary image data obtained by exposing an image sensor to light at a second time, and the primary image data is obtained from the image sensor substantially without moving the image sensor between the first time and the second time.

74. The apparatus of claim 73 wherein the first image frame is formed mainly from the primary image data obtained from a first sensor portion of the image sensor, the second image frame is formed mainly from the primary image data obtained from a second sensor portion of the image sensor, and the width of the second sensor portion is larger than the width of the first sensor portion.

75. The apparatus according to claim 69 wherein the duration of the first video shot is determined according to a predetermined time period.

76. The apparatus according to claim 69 wherein timing of the end of the second video shot is determined according to a detected movement or a voice.

77. The apparatus according to claim 69 wherein timing of the first video shot and timing of the second video shot are determined from the tempo of an audio signal.

78. The apparatus of claim 77 wherein the audio signal is associated with the identifier by using information obtained from server, which is configured to implement a social networking service.

79. The apparatus of claim 77 comprising a portable device, which in turn comprises an image sensor and one or more microphones, wherein the first image frame is formed from primary image data obtained from the image sensor, and the audio signal is captured by the one or more microphones.
